(19) United States
(12) Patent Application Publication
(10) Pub. No.: US 2020/0328485 A1
(43) Pub. Date: Oct. 15, 2020

(54) BATTERY CONTROL SYSTEM

(71) Applicant: Key Safety Systems, Inc., Sterling Heights, MI (US)

(72) Inventor: Matthias Volkmann, Kronberg (DE)

(21) Appl. No.: 16/097,688

(22) PCT Filed: Jun. 12, 2017
(86) PCT No.: PCT/US2017/036946

§ 371 Date: Oct. 30, 2018

Related U.S. Application Data
(60) Provisional application No. 62/349,275, filed on Jun. 13, 2016.

(51) Int. Cl. H01M 10/63; H01M 10/613; H01M 10/48; H01M 10/625

(52) U.S. Cl. CPC H01M 10/63; H01M 10/613; H01M 2220/20; H01M 10/625; H01M 2200/10; H01M 10/486

(57) ABSTRACT

The present invention describes a battery system. The battery system comprises a battery housing having at least one inlet and at least one outlet, at least one battery cell positioned within the battery housing, and a battery protecting unit connected to the battery housing through the at least one inlet at one or more first predetermined positions. The battery protecting unit is adapted to detect one or more abnormalities in the at least one battery cell and provide coolant to the at least one battery cell through a dynamically determined at least one conduit. The system detects abnormalities based on receiving one or more signals received from one or more sensors. The system also comprises a controlling unit for providing the control signals based on detection abnormalities in one or more battery cells through one or more sensors configured in the battery housing.

### BACKGROUND AND SUMMARY OF THE INVENTION

The present invention relates to a battery control system. More particularly, the present invention relates to a system and method for protecting a battery from thermal runaway and/or fire.

Thermal runaway is a very common problem in dry cells such as lithium-ion cells which needs immediate detection and quick action to control the problem. The thermal runaway is a state in which temperature of a battery cell increases rapidly and may cause damage to the battery cell and other adjacent battery cells. Additionally, in the state of thermal runaway, the increase in temperature accelerates the rate of temperature change and in turn leads to fire.

With the increase in demand of hybrid vehicles and other electric powered vehicles, the vehicle manufacturers are finding difficulty in overcoming the problem of thermal runaway. Several systems are in the market and being used by the vehicle manufacturer but these systems are unable to control thermal runaway. Therefore, there is a need for a system for monitoring and quickly detecting abnormalities in the battery cells and providing rapid cooling to the battery cells in which abnormalities are detected.

The present invention describes a battery system 100 for detecting and protecting one or more battery cells from one or more abnormalities. The system detects abnormalities based on receiving one or more signals from one or more sensors. On detecting abnormalities, the system provides either a coolant to protect the battery from thermal runaway or fire. The battery system 100 comprises a battery housing 102, and a battery protecting unit 104. The battery housing 102 comprises one or more battery cells 102 (a, b, c, d and e) connected to each other for providing power. The battery housing has one or more inlets 108 connected to a container or directly to a channel system for receiving coolant in the battery housing and in between the cells in case of an abnormality developing in the battery cells. The positions of the inlets on the battery housing are placed near to a particular battery cell 102 (a, b, c, d and e). The multiple inlets provide for rapid cooling. Once the coolant absorbs the heat, one or more outlets 110, preferably on top of the battery housing 102, releases the fumes/exhaust into the environment. The coolant is filled in the container and released into the battery housing 102 on receiving control signals from a controlling unit. This cooling can include liquefied gas, a non-reactive gas, including CO₂. The controlling unit provides the control signal or control signals based on detection of abnormalities in one or more battery cells through one or more sensors in the battery housing 102.

An embodiment of the present invention describes a battery system. The battery system comprises a battery housing having at least one inlet and at least one outlet, at least one battery cell positioned within the battery housing, and a battery protecting unit connected to the battery housing through the at least one inlet at one or more first predetermined positions, the battery protecting unit adapted to detect one or more abnormalities in the at least one battery cell and providing a coolant to the at least one battery cell through a dynamically determined at least one conduit.

According to one embodiment, the battery protecting unit comprises at least one container filled-in with at least the coolant to bring down one of the temperature and fire, thereby bringing down the one or more abnormalities of the at least one battery cell.

According to one embodiment, the container is connected to the at least one conduit through at least one throttle, the throttle having a diameter that defines flow quantity of the coolant.

According to one embodiment, the battery protecting unit comprises at least one vortex tube connected to the container for providing cold air to the battery.

According to one embodiment, the coolant is selected from a group consisting of air, compressed air, gas, CO₂, compressed gas, liquefied air, liquefied gas, solvent, solution, liquid nitrogen, and vapor.

According to one embodiment, one or more sensors is connected to the at least one of the battery housing, at least one battery cell, and battery protecting unit based on one or more second predetermined positions.

According to one embodiment, the at least one conduit is adapted to connect the at least one container to the at least one inlet on the battery housing.

According to one embodiment, the at least one outlet on the battery housing is provided for controlling release of the exhaust.

According to one embodiment, the battery protecting unit further comprises a controlling unit configured for performing the steps which comprises receiving one or more signals from one or more sensors connected to at least one of the battery housing, at least one battery cell, and battery protecting unit, detecting abnormalities in the at least one battery cell based on processing of signals received from one or more sensors, and providing controlled flow of the coolant to each battery cell in which the abnormality detected, through dynamically determined at least one conduit and in so doing control the battery fire.

According to one embodiment, the first predetermined position is a position between two battery cells to protect each of the battery cells from thermal runaway by providing the coolant.

According to one embodiment, the one or more abnormalities in the at least one battery cell comprises one of an increase in temperature of the at least one battery cell above a predefined threshold, temperature of the at least one battery cell in a predefined range, and increase in rate of change of temperature of the at least one battery cell above a predefined threshold.

According to one embodiment, the one or more abnormalities in the at least one battery cell comprises one of an increase in heat of the at least one battery cell above a predefined threshold, heat of the at least one battery cell in a predefined range, and increase in rate of change of heat of the at least one battery cell above a predefined threshold.

According to one embodiment, the controlling unit configured for performing the steps comprises monitoring rate of change of temperature in each of the battery cell, detecting abnormality in the battery cell based on at least one of an increase in temperature and rate of change of temperature of the battery cell above a predefined temperature, providing one or more control signals to the battery protecting unit on detecting the abnormality in the battery cell, and providing the coolant to each of the battery cells in which the abnormality is detected, on receiving the one or more control signals.

According to one embodiment, the controlling unit configured for providing one or more control signals to provide the coolant to one or more battery cells adjacent to each of the battery cells in which the abnormality is detected.

According to one embodiment, the controlling unit validates the detected abnormality based on processing signals from one or more sensors other than the sensors which detected the abnormality.

According to one embodiment, the controlling unit further configured for providing an alert signal to an occupant of a vehicle in which the battery system is installed.

Another embodiment of the present invention describes a battery system. The battery system comprises a battery housing having at least one inlet and at least one outlet, at least one battery module positioned within the battery housing, at least one container filled-in with a coolant to bring down one of a temperature and fire, and a battery protecting unit operatively connected to the battery housing and the container through the at least one inlet at one or more first predetermined positions, the battery protecting unit adapted for detecting one or more abnormalities in the at least one battery module and providing the coolant to the at least one battery module through a dynamically determined at least one conduit.

Yet another embodiment of the present invention describes a battery system which comprises a battery housing having at least one inlet and at least one outlet, at least one battery cell positioned within the battery housing, and a battery protecting unit comprises at least one container filled-in with a coolant, the battery protecting unit operationally connected to at least one sensor for providing the coolant to the at least one battery cell through at least one conduit, on detecting one or more abnormalities in the at least one battery cell.

Yet another embodiment of the present invention describes a battery system which comprises at least one battery housing, each battery housing having at least one inlet and at least one outlet, at least one battery cell positioned within the battery housing, and a battery protecting unit connected to the at least one battery housing through the at least one inlet at one or more first predetermined positions, the battery protecting unit adapted for detecting one or more abnormalities in the at least one battery cell and providing a coolant to the at least one battery cell through a dynamically determined at least one conduit.

Yet another embodiment of the present invention describes a system for protecting a battery. The system comprises a battery protecting unit connected to at least one battery housing through at least one inlet at one or more first predetermined positions, the battery protecting unit configured for detecting one or more abnormalities in the at least one battery cell and providing a coolant to the at least one battery cell through a dynamically determined at least one conduit.

A further embodiment of the present invention describes a method for protecting the battery. The method comprises monitoring rate of change of temperature in at least one battery cell, detecting abnormality in the battery cell based at least on an increase in temperature and rate of change of temperature of the battery cell above a predefined temperature, providing one or more control signals to a battery protecting unit on detection of abnormality in the battery cell; and providing a coolant to each of the battery cell in which abnormality is detected, on receiving the one or more control signals.

### BRIEF DESCRIPTION OF THE DRAWINGS

FIG. 1 illustrates a block diagram of a battery system, according to an embodiment of the present invention.

FIG. 2 diagrammatically illustrates a battery system according to one exemplary embodiment of the present invention.

FIG. 3 diagrammatically illustrates a Vortex tube for providing cold air to a battery system, according to one exemplary embodiment of the present invention.

FIG. 4 shows another embodiment of the invention.

FIG. 5 diagrammatically illustrates an inflator for providing coolant to a battery system, according to one exemplary embodiment of the present invention.

FIG. 6 illustrates a flow chart of a method for protecting a battery, according to an exemplary embodiment of the present invention.

FIG. 7 shows battery cells with integrated cooling channels placed adjacent to one another.

FIG. 8 shows the component parts of a serpentine cooling channel.

FIG. 9 is an exploded view of an outlet.

FIG. 10 is an exploded view of an inlet.

### DETAILED DESCRIPTION OF THE DRAWINGS

The embodiments of the present invention will now be described in detail. However, the present invention is not limited to the embodiments. The present invention can be modified in various forms. Thus, the embodiments of the present invention are only provided to explain more clearly the present invention to the ordinarily skilled in the art of the present invention.

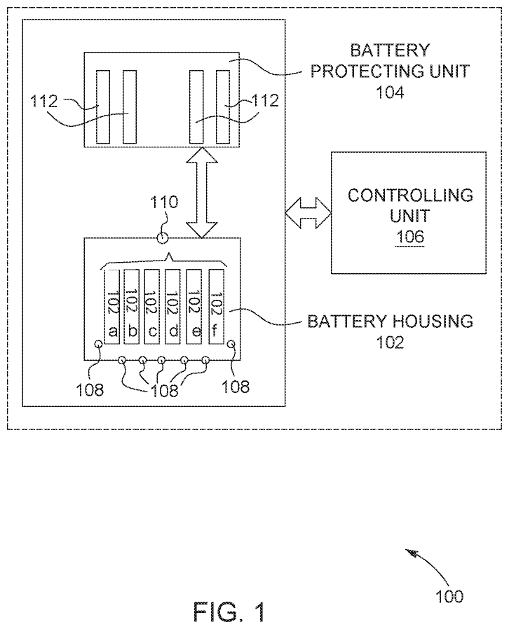

FIG. 1 illustrates a block diagram of a battery system, according to an embodiment of the present invention. The battery system comprises a battery housing 102, and a battery protecting unit 104. The battery housing 102 comprises one or more battery cells: 102a, 102b, 102c, 102d, 102e and 102f connected to each other in either series or parallel based on system requirements. The battery housing has one or more inlets 108 for allowing release of coolant in the battery housing. The battery housing also has one or more outlets 110 to release any exhaust in the environment. The position of each inlet on the battery housing is placed near to the battery cell 102 a-f so as to provide quick and effective cooling. The outlet on the battery housing is configured with a controlling mechanism such as a valve to control the release of the exhaust in the environment so as to properly utilize the cooling of the coolant.

In one embodiment, the battery protecting unit comprises a control unit 106 and one or more containers (not shown in figure) filled-in with the coolant to bring down the temperature or fire. In one embodiment, the container is a pressure vessel such as an airbag inflator filled with the appropriate pressurized gas or fluid. In one embodiment, the controlling unit 106 is a part of the battery protecting unit. In another embodiment, the controlling unit 106 is external to the battery protecting unit 104. In yet another embodiment, the controlling unit 106 is a part of a battery management system. In one embodiment, the one or more containers are connected to one or more inlets on the battery housing through one or more conduits.

In one embodiment, the battery protecting unit 104 is connected to the battery housing 102 at one or more first predetermined positions. In one embodiment, a part of the battery protecting unit is within the battery housing and remaining part is outside the battery housing. The battery protecting unit 104 detects one or more abnormalities in the at least one battery cell and provides coolant to the at least one battery cell through a dynamically determined at least one conduit. In one embodiment, the battery protecting unit includes, but is not limited to a controlling unit configured for dynamically determining the at least one conduit by performing the steps which comprises identifying the battery cell in which abnormality occurred, identifying severity of the abnormality in the battery cell in which abnormality occurred, and identifying the at least one conduit connected to the at least one inlet closest to the battery cell in which the abnormality occurred.

The one or more abnormalities in the at least one battery cell includes, but is not limited to an increase in temperature of the at least one battery cell above a predefined threshold, an increase in temperature of the at least one battery cell in a predefined range, or an increase in rate of change of temperature of the at least one battery cell above a predefined threshold. In one embodiment, the first predetermined position is a position between two battery cells to protect each of the battery cells from either thermal runaway or fire by providing the coolant.

In one embodiment, the battery protecting unit comprises at least one container filled-in with the coolant to bring down the temperature or fire. The container is connected to the at least one conduit through at least one throttle; the throttle having diameter which defines the flow quantity of the coolant by constriction.

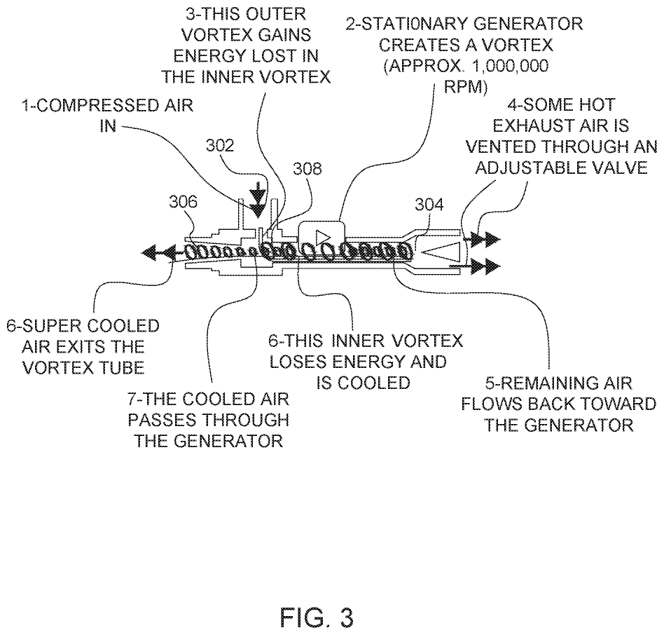

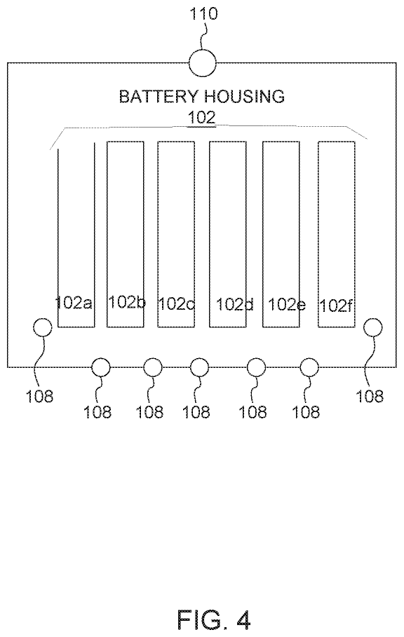

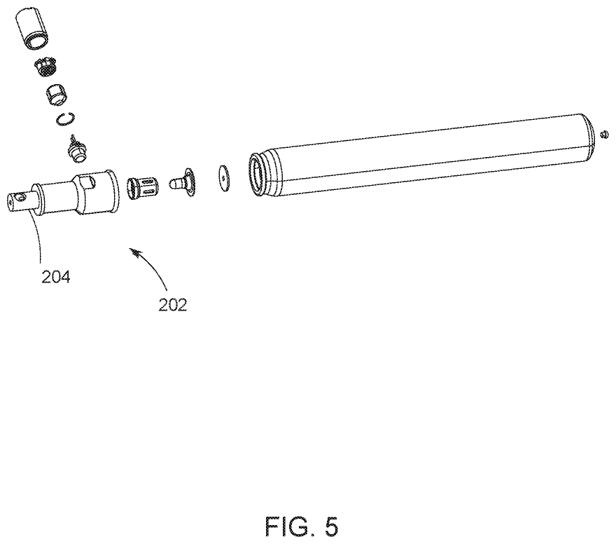

In another embodiment, the battery protecting unit comprises at least one vortex tube connected to the container for providing cold air to the battery. The detail of the vortex tube is explained in FIG. 3.

The coolant is used to cool down the temperature of the battery cell, which includes but is not limited to air, compressed air, gas, compressed gas, liquefied air, liquefied gas, solvent, solution, liquid nitrogen, and vapor.

The system also comprises one or more sensors. These sensors are placed at appropriate positions (i.e. one or more second predetermined positions) such as the battery housing, battery cell, and/or battery protecting unit.

In one embodiment, the battery protecting unit includes, but is not limited to a controlling unit configured for performing the steps which comprises receiving one or more signals from one or more sensors connected to at least one of the battery housing, at least one battery cell, and battery protecting unit, detecting abnormalities in the at least one battery cell based on processing of signals received from one or more sensors, and providing instruction to the container in order to release the coolant in controlled quantity to each of battery cell in which the abnormality is detected, through dynamically determined at least one conduit.

The one or more abnormalities in the at least one battery cell comprises one of an increase in temperature of the at least one battery cell above a predefined threshold, temperature of the at least one battery cell in a predefined range, and increase in rate of change of temperature of the at least one battery cell above a predefined threshold.

The one or more abnormalities in the at least one battery cell comprises one of an increase in heat of the at least one battery cell above a predefined threshold, heat of the at least one battery cell in a predefined range, and increase in rate of change of heat of the at least one battery cell above a predefined threshold.

The controlling unit configured for performing the steps comprises monitoring rate of change of temperature in each of the battery cells, detecting abnormality in the battery cell based on at least one of an increase in temperature and rate of change of temperature of the battery cell above a predefined temperature, providing one or more control signals to the battery protecting unit on detecting the abnormality in the battery cell, and providing the coolant to each of the battery cells in which the abnormality is detected, on receiving the one or more control signals.

In one embodiment, the controlling unit validates the detected abnormality based on processing signals from one or more sensors other than the sensors which detected abnormality.

In one embodiment, the controlling unit is configured for providing an alert signal to an occupant of a vehicle in which the battery system is installed. The alert signal includes but is not limited to audio, image, video, and light. In one embodiment, the color of light depends upon severity of abnormality.

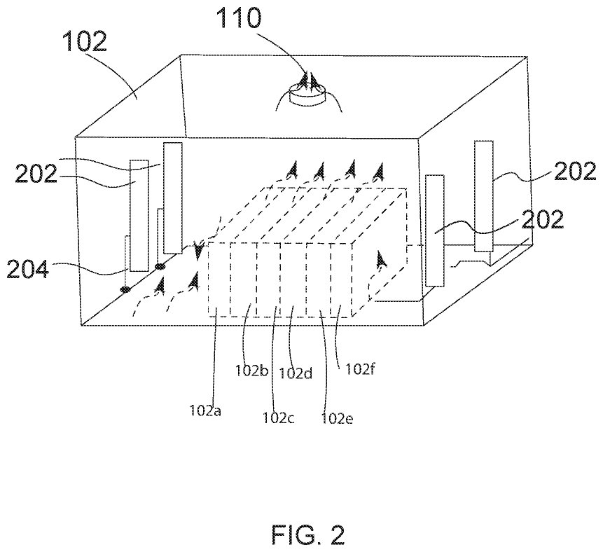

FIG. 2 diagrammatically illustrates further features of a battery housing 102 according to the present invention. The battery housing 102 has multiple inlets 108 and one outlet 110, six battery cells a, b, c, d, e, f positioned within the battery housing 102; and four inflators 202. The inflators are connected to the battery housing through four conduits 204 in order to provide quick and effective cooling to the battery cells in which abnormality occurred. As can be appreciated, any number of conduits 204 can be used.

FIG. 3 diagrammatically illustrates a Vortex tube for providing cold air to a battery system, according to one exemplary embodiment of the present invention. The vortex tube has a first opening 302, a second opening 304, a third opening 306, a generating section 308. The first opening 302 is connected to the container to receive air from the container. The generating section 308 is connected to the first opening 302 for rotating the air at a very high speed and thereby splits the air into a hot air in an exterior rotating layer and a cold air in an interior rotating layer and forms a vortex. The second opening 304 is adapted to release the hot air from the vortex tube and return the cold air towards the third opening 306. The third opening 306 is adapted to release the cold air from the vortex tube. The air rotating in the exterior rotating layer absorbs heat to form a hot air flow. The air rotating in the interior rotating layer releases the heat to get cooled.

FIG. 6 illustrates a flow chart of a method for protecting a battery, according to an exemplary embodiment of the present invention. At step 602, rate of change of temperature is monitored in at least one battery cell. At step-604, abnormality in the battery cell is detected based at least on an increase in temperature and rate of change of temperature of the battery cell above a predefined temperature. At step 606, one or more control signals are provided to a battery protecting unit on detection of abnormality in the battery cell. At step 608, a coolant is provided to each of the battery cells in which abnormality is detected, on receiving the one or more control signals.

In one embodiment, a controlling unit monitors temperature and rate of change of temperature of one or more battery cells in a battery housing based on one or more signals received from one or more sensors. In case of increase in temperature and/or rate of change of temperature of the at least one battery cell above a predefined temperature, the controlling unit determines nearest/appropriate one or more inlets for providing coolant to the at least one battery cell in which abnormality occurred and sends a control signal to a container/inflator to release the coolant in the battery housing through determined one or more inlets. The controlling unit controls the flow of coolant through one or more inlets in order to control the rise in temperature.

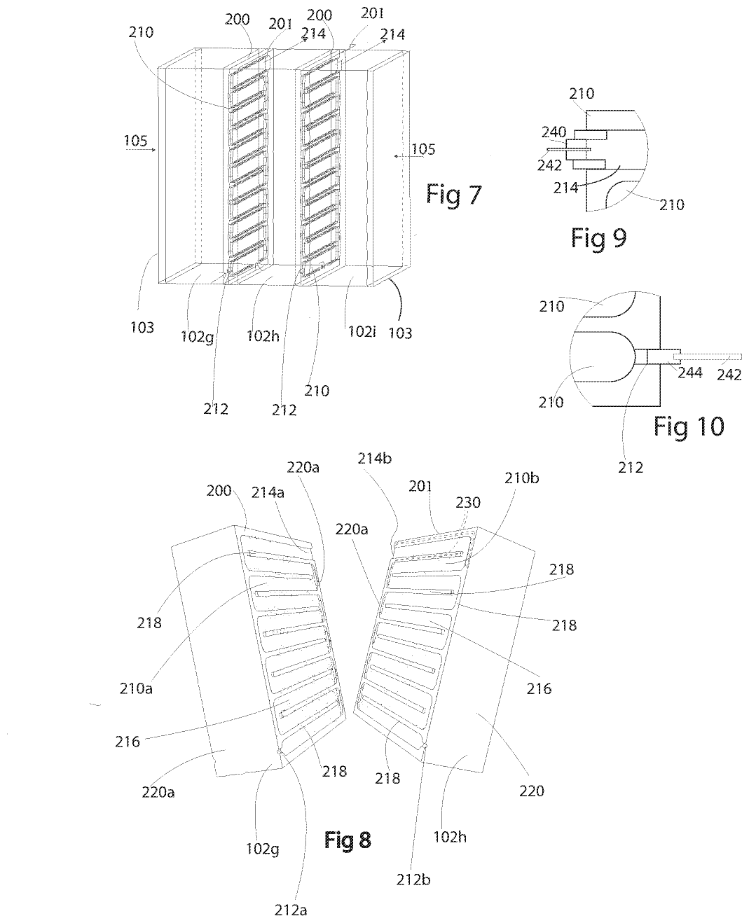

FIG. 7 shows another embodiment of the invention in which at least two battery cells 102g, 102h and 102i are positioned adjacent each other. Each cell is basically a rectangular cuboid in shape with a top and bottom and a plurality of sides. As can be seen in FIG. 7 opposing sides 200 and 202 of cells 102g and 102h mate with each other and opposing sides 200 and 202 of cells 102h and 102i mate with each other. The cells 102g-102i can be placed within a frame or housing diagrammatically shown by walls 103. Arrows 105 illustrate the clamping force exerted by the housing or frame upon the cells to hold the cells in close position. Each side 200 and 202 cooperate to form a cooling unit in the form of a serpentine cooling channel 210. More particularly, each side 200 and 202 has formed thereon one-half of the serpentine cooling channel 210. The serpentine channel 210 begins at an inlet 212 and ends at an outlet 214 in order to receive and carry away cooling fluid within tubes and hoses. In order to convey a sufficient quantity of heat away from the cells and regulate the temperature of the cells the serpentine channel is preferably located at the mating sides of two cells and has shown advantageous results. The channel 210 is designed to cover substantially the entire side of a cell which enables the cooling fluid to cool hot spots in a cell. By positioning a cooling mechanism or battery protection unit such as the serpentine channel in between adjacent cells prevents the heat from one cell that might have an increased temperature from heating up an adjacent cell.

To achieve this a cooling mechanism in the form of a serpentine channel 210 each of the mating sides 200 and 202 are formed with one-half of the channel 210 as more clearly shown in FIG. 8. FIG. 8 shows two adjacent battery cells such as 102g and 102h separated from one another. The mating sides 200 and 202 are clearly visible. The relationship between any two adjacent cells would be the same. By integrating the cooling mechanism into a side of the battery cells provides for efficient packaging and optimum heat transfer. Alternatively, the cooling mechanism such as the serpentine channel can be an independent part placed between adjacent battery cells rather than being integrated therein as described above. Side 200 and 202 includes one-half of the serpentine channel 210 which are designated as 210a and 210b. As can be seen each of the half-channel portions 210a and 210b resembles a serpentine or zig-zag path through which fluid and gas can flow. Each half channel 210a and 210b comprises a recessed portion 216 and a number of risers 218 which extend inwardly from respective end-sides 220 and 220a of each cell. When the sides 200 and 202 are mated together the completed serpentine channel 210 is formed with its inlet 212 and outlet 214. Each side 200 and 202 contains one-half of an outlet 214a and 24b. These halves are shown as 212a and 212b which are formed as half-tubes and when the sides 200 and 202 are mated together the tubular outlet is formed. The housing 103 and compression forces 105 mentioned above keep the cells together. FIG. 8 also shows the inclusion of a fluid seal 230 can be incorporated within or upon the risers 218 to provide added sealing as needed. To receive and remove the cooling fluid and/or gas from the serpentine channel 210 connector can be secured to the inlet outlet 212, once the cells have been placed together forming the channel 210. The cross-section dimension of the channel 210 can be about 3 mm deep and 10 mm wide. As can be appreciated each half-channel will be about 1.5 mm deep and 10 mm wide. FIG. 9 is an exploded view of the outlet 214 with a connector 240 secured to the outlet 214. A fluid carrying tube 242 is in fluid contact with the connector and outlet to transport fluid/gas away from the battery. The connector can be secured to the outlet 214 in many ways such as by a threaded fit or pressure-tight fit or using other known methods. As can be appreciated from FIG. 8 the illustrated inlet 212 is formed by to half-cylinders and when the battery sides are secured together the inlet 212 is cylindrical in shape. FIG. 10 is an exploded view of the inlet 212 and shows a connector 244 press fit into the inlet with a distribution hose or tube 242 extending there from to permit cooling fluid/gas to enter into the channel 210 and cool the battery cells.

All equivalent relationships to those illustrated in the drawings and described in the application are intended to be encompassed by the present invention. The examples used to illustrate the embodiments of the present invention, in no way limit the applicability of the present invention to them. It is to be noted that those with ordinary skill in the art will appreciate that various modifications and alternatives to the details could be developed in the light of the overall teachings of the disclosure, without departing from the scope of the invention.

1. A battery system comprising:
a battery housing having at least one inlet and at least one outlet;
at least one battery cell positioned within the battery housing; and
a battery protecting unit connected to the battery housing through the at least one inlet at one or more first predetermined positions,
the battery protecting unit adapted to detect one or more abnormalities in the at least one battery cell and providing a coolant to the at least one battery cell through a dynamically determined at least one conduit, wherein the battery protecting unit has at least one container filled-in with the coolant to bring down one of the temperature and fire, thereby bringing down the one or more abnormalities of the at least one battery cell, wherein the one conduit includes a serpentine channel formed between adjacent battery cells, wherein one-half of the serpentine channel is associated with one cell and another one-half of the serpentine channel is associated with the adjacent cell.

2. (canceled)

3. (canceled)

4. (canceled)

5. The system of claim 1, wherein the container is connected to the at least one conduit through at least one throttle,
the throttle having diameter defines flow quantity of the coolant.

6. The system of claim 1, wherein the battery protecting unit comprises at least one vortex tube connected to the container for providing cold air to the at least one battery cell.

7. The system of claim 1, wherein the coolant is selected from a group consisting of air, compressed air, gas, compressed gas, liquefied air, liquefied gas, solvent, solution, liquid nitrogen, and vapor.

8. The system of claim 1 further comprising one or more sensors connected to the at least one of the battery housing, at least one battery cell, and battery protecting unit based on one or more second predetermined positions.

9. The system of claim 1, wherein the at least one conduit is adapted to connect the at least one container to the at least one inlet on the battery housing.

10. The system of claim 1, wherein the at least one outlet on the battery housing is provided for controlling release of the exhaust.

11. The system of claim 1, wherein the battery protecting unit further comprises a controlling unit configured for performing the steps comprises:
receiving one or more signals from one or more sensors connected to at least one of the battery housing, at least one battery cell, and battery protecting unit;
detecting abnormalities in the at least one battery cell based on processing of signals received from one or more sensors; and
providing controlled flow of the coolant to each battery cell in which the abnormality detected, through a dynamically determined at least one conduit.

12. The system of claim 1, wherein the first predetermined position is a position between two battery cells to protect each of the battery cells from thermal runaway by providing coolant.

13. The system of claim 1, wherein the one or more abnormalities in the at least one battery cell comprises one of an increase in temperature of the at least one battery cell above a predefined threshold, temperature of the at least one battery cell in a predefined range, and increase in rate of change of temperature of the at least one battery cell above a predefined threshold.

14. The system of claim 1, wherein the one or more abnormalities in the at least one battery cell comprises one of an increase in heat of the at least one battery cell above a predefined threshold, heat of the at least one battery cell in a predefined range, and increase in rate of change of heat of the at least one battery cell above a predefined threshold.

15. The system of claim 8, wherein the controlling unit configured for performing the steps comprises:
monitoring rate of change of temperature in each of the battery cells;
detecting abnormality in the battery cell based on at least one of an increase in temperature and rate of change of temperature of the battery cell above a predefined temperature;
providing one or more control signals to the battery protecting unit on detecting the abnormality in the battery cell; and
providing the coolant to each of the battery cells in which the abnormality is detected, on receiving the one or more control signals.

16. The system of claim 8, wherein the controlling unit is configured for providing one or more control signals to provide the coolant to one or more battery cells adjacent to each of the battery cells in which the abnormality is detected.

17. The system of claim 8, wherein the controlling unit validates the detected abnormality based on processing signals from one or more sensors other than the sensors which detected abnormality.

18. The system of claim 8, wherein the controlling unit is further configured for providing an alert signal to an occupant of a vehicle in which the battery system is installed.

19. A battery system comprising:
a battery housing having at least one inlet and at least one outlet;
at least one battery module positioned within the battery housing;
at least one container filled-in with a coolant to bring down one of a temperature and fire; and
a battery protecting unit operatively connected to the battery housing and the container through the at least one inlet at one or more first predetermined positions,
the battery protecting unit adapted for detecting one or more abnormalities in the at least one battery module and providing the coolant to the at least one battery module through a dynamically determined at least one conduit, wherein the battery protecting unit has at least one container filled-in with the coolant to bring down one of the temperature and fire, thereby bringing down the one or more abnormalities of the at least one battery cell, wherein the one conduit includes a serpentine channel formed between adjacent battery cells, wherein one-half of the serpentine channel is associated with one cell and another one-half of the serpentine channel is associated with the adjacent cell.

20. A method for protecting a battery, comprising:
monitoring rate of change of temperature in at least one battery cell;
detecting abnormality in the battery cell based at least of an increase in temperature and rate of change of temperature of the battery cell above a predefined temperature;
providing one or more control signals to a battery protecting unit on detection of abnormality in the battery cell; and
providing a coolant to each of the battery cell in which abnormality is detected, and providing coolant in between adjacent cells wherein the coolant is guided through a serpentine channels between adjacent cells on receiving the one or more control signals.

21. (canceled)

22. (canceled)
